(19) United States
(12) Patent Application Publication
(10) Pub. No.: US 2004/0080622 A1
(43) Pub. Date: Apr. 29, 2004

(54) Input device, webcam and screen having a voice input function

(76) Inventor: Bernd Gombert, Seefeld (DE)

Correspondence Address: Leopold Presser, Scully Scott Murphy & Presser, 400 Garden City Plaza, Garden City, NY, 11530, US

(21) Appl. No.: 10/450,088

(22) PCT Filed: Nov. 18, 2002
(86) PCT No.: PCT/EP02/12918

(30) Foreign Application Priority Data
Nov. 16, 2001 (DE) 10156457.0

(51) Int. Cl. H04N 5/225

(52) U.S. Cl. 348/207.99

(57) ABSTRACT

The present invention relates to a manual input device (1, 1″) for the generation of drive signals for real and/or virtual objects. According to the invention, a microphone (3) for the recording and conversion of acoustic voice-control signals of a user is incorporated in the housing (2, 2′) of the manual input device. In this way, the user is relieved of manipulating an input device (1, 1′). The interface (8) of the input device (1, 1′) to a computer (7) can in this case also be used for the transmission of acoustic voice-control signals or their evaluation. In this way, the number of connections (6) occupied in the computer (7) is reduced.

In the housing of the manual input device (1, 1′), there may furthermore be provided a processing unit (4), such as, for example, an ASIC, that subjects the output signals of the microphone (3) to an algorithm for automatic speaker identification, voice recognition, voice analysis and/or voice interpretation. In that case, not only acoustically or electrically converted signals are transmitted by the manual input device (1, 1′) to the computer unit (7), but, on the contrary, commands are transmitted that can be processed directly by a computer (7). The manual input device (1, 1′) may advantageously be operated together with a driver software that automatically activates a voice-control function (recording and conversion of acoustic voice-control signals) as soon as the manual input device (1, 1′) is connected to a connection (6) provided for the purpose in the computer unit (7). In that case, the voice-control activation function can be incorporated directly in the driver software that is provided for the conversion of the drive signals for the cursor control or object control. According to the invention, the converted and processed voice-control signals can be transmitted together with the other drive commands via a common wire-connected or wireless interface (8) to the computer unit (7).

The present invention relates to a manual input device for the generation of drive signals for real and/or virtual objects, a display screen and also to an Internet camera attachment for a computer device.

### SHORT DESCRIPTION OF THE PRIOR ART

Manual input devices for the input of information items, such as keyboards, mice, trackballs and joysticks are currently widespread. They are used to control cursors, mouse pointers etc. in order, for example, to be able to navigate through a virtual scene or to move virtual objects that are displayed graphically on a display screen. Whereas keyboards and mice require a solid support surface in order to be able to be operated in an efficient manner, if a touch screen or a touch panel is used, it is possible to point with the finger directly at objects that are displayed on the display screen without needing further space-consuming attachment devices on the desk.

According to the prior art, various solutions are currently available for the problem of real-time movement control of virtual objects, each of said solutions being optimized for a special application purpose. In order to be able to explain as an approach some of the most important of these solutions that are relevant to the comprehension of the present invention, it is necessary to deal briefly with their most important technical features.

One possibility for the real-time movement control of virtual objects has emerged recently as a result of the development of input devices for computers that make possible the simultaneous input of drive signals of a plurality of degrees of freedom that are independent of one another. The possibilities thereby provided far exceed those that exist, for example, if a mouse is used, which can be controlled only two-dimensionally (for example, on the support surface of a desk). Although it is also known to provide a mouse, for example, with additional switches, said switches have the disadvantage that they do not make possible the input of analog data, but are, on the contrary, limited to binary data (on/off).

The prior art also discloses various input devices that can generate analog drive signals having different degrees of freedom that are independent of one another, in which case each of said analog signals can be used as a parameter value in controlling virtual objects. Such manually controllable input system that permit navigation in three dimensions are currently successfully used in a number of very varied technical application fields.

For example, the patent U.S. Pat. No. 5,757,360 discloses an egg-shaped input device for computers that can be moved by a user's hand freely in space, determines his instantaneous positions, movement directions, speeds and accelerations and transmits these kinematic data wirelessly to a computer. In this case, an analog movement procedure is identified in the form of a movement pattern from which movement commands are derived and converted into an animated graphic display. The movement patterns are then automatically detected with the aid of a pattern detection algorithm. In addition, control commands are generated. The disadvantage of said method is that it cannot be freely specified since user movement procedures that are detected in analog form by the input device are assigned to corresponding movement procedures of stored movement sequences of an animated graphic display and can be displayed only as such.

Input devices that have manually actuable force/moment sensors are disclosed, for example, in the patents DE 36 11 336 C2, DE 37 64 287 and also EP 0 979 990 A2.

From the last-mentioned European Patent EP 0 979 990 A2, it is known to use such a force/moment sensor to control operating elements of a real or virtual mixing and control console, for example to create and design new colour, light and/or sound compositions. In this case, intuitive spatial control in three translational and also three rotary degrees of freedom can advantageously be transmitted into stepless spatial mixing or controlling of a large number of optical and/or acoustic parameters. For the purpose of control, a pressure is exerted on the operating surface of the input device and a pulse is thereby generated that is detected with the aid of the force/moment sensor and is converted into a vector pair comprising a force vector and a moment vector. If certain characteristic pulse requirements are fulfilled in this process, an object-specific control operation and/or a technical function can, for example, be initiated by switching to an activation state or terminated again by switching to a deactivation state.

It is furthermore known from said publication to fit the said force/moment sensor as an operating element of a 3D input device laterally on a touch screen so that the longitudinal axis of the operating element is parallel to the display surface and operating surface of the touch screen. However, this is associated with the disadvantage that the viewing direction of the touch screen does not coincide with the longitudinal axis of the operating element. This has the result that the hand/eye coordination of the user is made difficult since the directions of the control movements of the operating element and displayed object movements on the display screen do not coincide in the event of an unfavourable axis positioning of the operating element.

In the case of the use of three-dimensional input devices, such as, for example, force/moment sensors, in the field of CAD (computer-aided design) applications, the mode of operation is widespread in which the user operates in the one hand the three-dimensional input device and a normal computer mouse (two-dimensional computer mouse) with the other hand. At the same time, it is typical of the execution of CAD activities that numerical inputs (dimensional data, etc.) have to be effected at certain points in the object processed.

In the abovementioned two-hand mode of operation in the CAD field, the problem therefore occurs that the user has to release the hand from one of the input devices mentioned in order, for example, to perform the input of numerical information or of (shortcut) commands by means of a keyboard. The hand then has to be returned again from the keyboard to the input device. It is obvious that this change in the hand position involves disruptions in the working procedure, in particular, if it is borne in mind that the user's view is not to be deflected, if possible, from the display screen surface.

One conceivable solution would be the input of the numerical data by means of voice-control signals. For this purpose, in accordance with the prior art, the user has to wear on his head an attachment that carries a microphone. Said attachment (“headset”) has to be worn by the user. This solution also has ergonomic problems since, on the one hand, the user now has to manipulate a total of four input devices, namely the force/moment sensor, the normal computer mouse, the keyboard and the microphone. In addition, the problem may occur that the number of connections, for example on the rear of the computer, to which the said four devices are to be connected are insufficient, or duplicate occupancies occur if at least two of the said devices need the same connection type (for example, USB, RS 232 C).

### OBJECT OF THE PRESENT INVENTION

It is therefore the object of the present invention to solve the above problems by appropriate design changes on the part of a manual input device.

This object is achieved, according to the invention, by the features of the independent claims. The dependent claims develop the central idea of the invention further particularly advantageously.

### SYNOPSIS OF THE PRESENT INVENTION

In accordance with the invention, a manual input device is provided for the generation of drive signals for real and/or virtual objects. The manual input device can consequently be used not only to drive computers, but also to drive robots or other real objects. According to the invention, a microphone is built into the housing of the manual input device for recording and converting a user's acoustic voice-control signals into electrical signals. This advantageous embodiment achieves two advantages by means of a single measure: on the one hand, the user is relieved of manipulating an input device as a result of the incorporation of the microphone into the housing of the manual input device. On the other hand, the interface of the input device can also be used for the transmission of acoustic voice-control signals or their evaluation. Consequently, the number of interfaces occupied in the computer is reduced. According to the invention, the avoidance of two disadvantages in the prior art can therefore be achieved by a single, simple measure.

Furthermore, there can be provided in the housing of the manual input device a processing unit, for example an application-specific integrated semiconductor circuit (ASIC), that subjects the output signals of the microphone to an algorithm for automatic speaker identification, voice recognition, voice analysis and/or voice interpretation. In this connection, if a voice recognition algorithm independent of the voice of the particular speaker is implemented, the implementation of the automatic speaker identification is unnecessary. The manual input device therefore transmits not only acoustically or electrically converted signals to the computer unit, but, on the contrary, transmits commands that can be directly processed by a computer. Incidentally, “voice control” is also to be understood as meaning the input of (for example, numerical) values or texts. Voice control is therefore also to be understood in the sense of “voice input” (input of information items and control commands).

The manual input device may, for example, be a conventional computer mouse, a force/moment sensor or a keyboard.

The voice-control function, i.e. the activation of the recording and conversion of acoustic voice-control signals by the combination of an input device and microphone may at the same time be capable of being activated by actuating the manual input device (for example, by means of a special key).

The manual input device may be operated together with a driver software that automatically activates the voice-control function (recording and conversion of acoustic voice-control signals) as soon as the manual input device is connected to a connection of the computer unit provided therefor. This is a particularly advantageous solution because, together with the connection of the input device, not only is the input of standard drive commands (cursor-control or mouse-pointer control, etc.) made possible for the computer unit, but, at the same time, the voice-recognition function is also provided.

In this connection, the voice-control activation function can be incorporated directly in the driver software that is provided for converting the other drive signals (cursor control or object control). This has the advantage that the user does not have to install two different software packages for the manual input device and the voice control, but, on the contrary, the drive-signal function as well as the voice-control function can be installed at the same time by installing a single driver software.

According to the invention, the converted, interpreted and processed voice-control signals can be transmitted together with the other drive commands (for example, for cursor control, etc.) via a common wire-connected or wireless interface to a computer unit. Consequently, according to the invention, an additional interface is not needed for the transmission of the recorded acoustic voice-control signals converted into commands that can be executed by the computer, as a result of which, as already explained above, the number of interfaces is reduced. Such an input device is advantageous, in particular, in the field of CAD, desktop publishing or the like.

In accordance with yet a further aspect of the present invention, an Internet camera attachment is provided for a computer device. Such camera attachments are often described also as webcams. According to the invention, a microphone is incorporated in the housing of the Internet camera attachment. Alternatively, a microphone can also be permanently connected to the housing of the webcam or mounted on it.

The invention relates equally to voice-input microphones incorporated in the display-screen housing.

### SHORT DESCRIPTION OF THE DRAWINGS

Further characteristics, features, advantages and efficacies of the underlying invention emerge from the subordinate dependent claims and also from the detailed description below of four different exemplary embodiments for the generation of control signals for the real-time movement control of real or virtual objects, which exemplary embodiments are depicted in the following drawings. In the drawings:

FIG. 1 shows a first exemplary embodiment in which a microphone for the recording and conversion of acoustic voice-control signals into electrical signals, an ASIC for automatic speaker identification, voice recognition, voice analysis and voice interpretation, and also a key for the manual activation of the voice-control function are incorporated in the housing of a computer mouse,

FIG. 2 shows a second exemplary embodiment in which a microphone for the recording and conversion of acoustic voice-control signals into electrical signals, an ASIC for automatic speaker identification, voice recognition, voice analysis and voice interpretation, and a key for the manual activation of the voice-control function are incorporated in the housing of a computer keyboard,

FIG. 3 shows a third exemplary embodiment in which a microphone for the recording and conversion of acoustic voice-control signals into electrical signals, an ASIC for automatic speaker identification, voice recognition, voice analysis and voice interpretation, and a key for the manual activation of the voice-control function are incorporated in the housing of an Internet camera attachment (“webcam”), and

FIG. 4 shows a fourth exemplary embodiment in which a microphone for the recording and conversion of acoustic voice-control signals into electrical signals, an ASIC for automatic speaker identification, voice recognition, voice analysis and voice interpretation, and a key for the manual activation of the voice-control function are incorporated in the housing of a computer display screen.

### DETAILED DESCRIPTION OF THE INVENTION

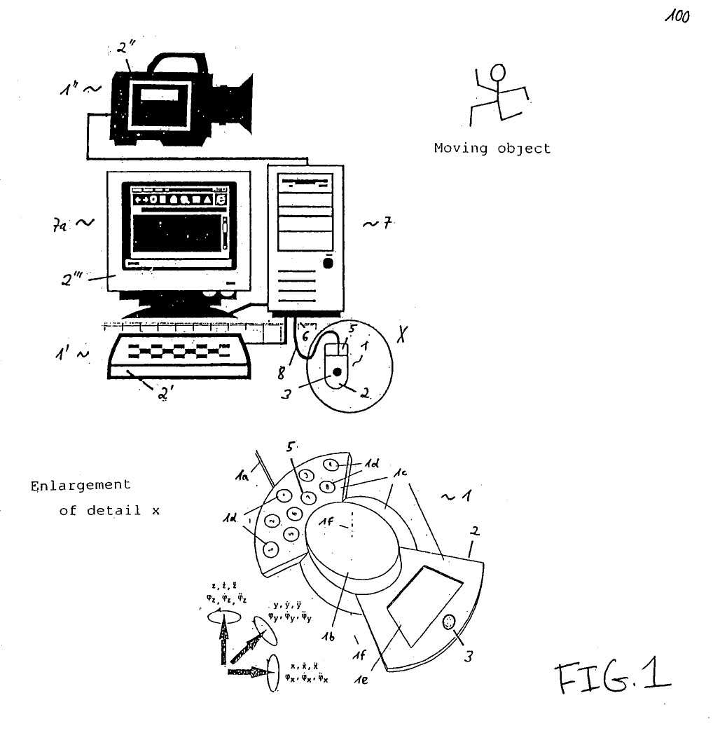

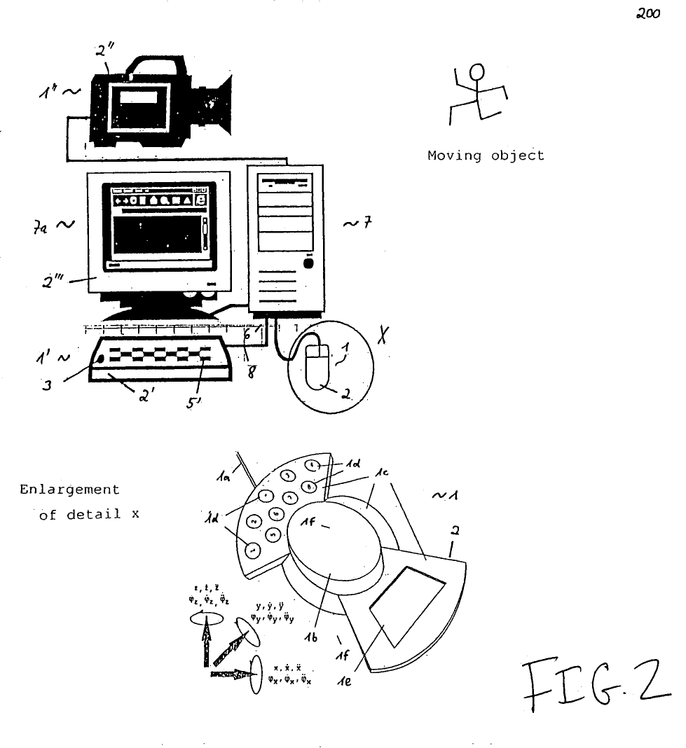

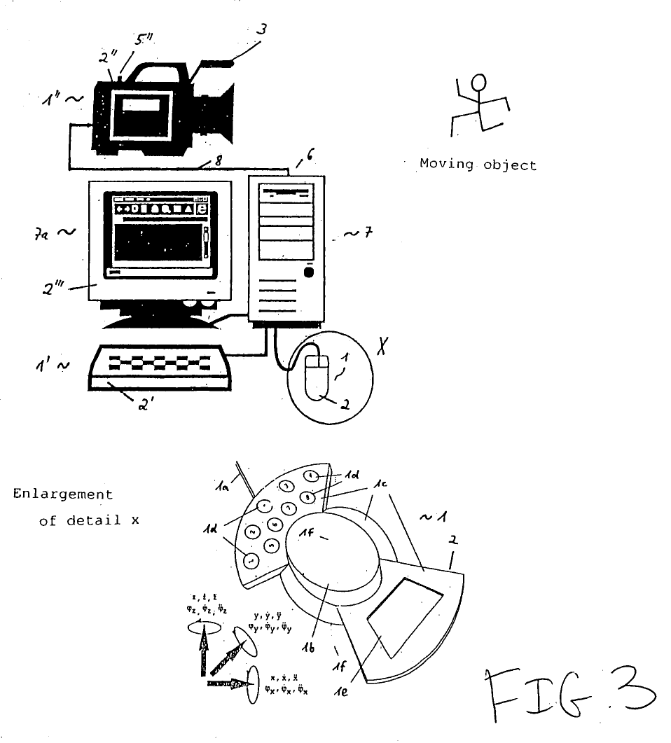

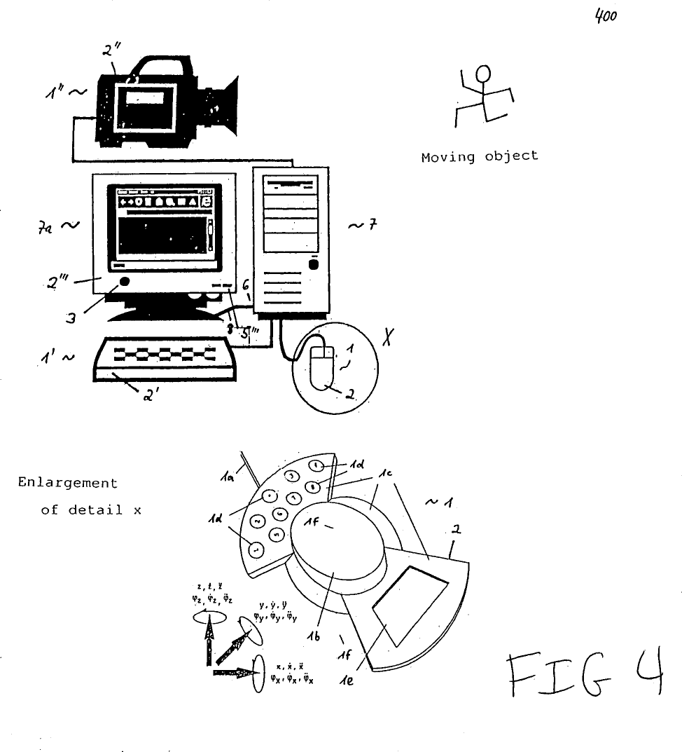

The functions of the components contained in four different exemplary embodiments of the present invention, such as are shown in FIGS. 1 to 4, are described in greater detail below. The meaning of the symbols provided with reference characters in FIGS. 1 to 4 can be found in the accompanying list of reference characters.

FIGS. 1 to 4 depict a computer 7 having a display screen 7a, a mouse or a force/moment sensor 1, and also a keyboard 1′ as manual input devices for the input of control commands, and an Internet camera attachment 1″ (“webcam”). Said computer 7 is only one example of an environment in which real and/or virtual objects can be driven. For example, a CAD program may be installed in the computer 7.

According to the invention, the manual input devices 1, 1′ and/or the webcam 1″ are extended so that they each have, as depicted in FIGS. 1 to 4, an incorporated microphone 3. By means of said microphone 3, the user's voice-control signals can be recorded, converted into electrical signals and, by means of a processing unit 4 (microprocessor), for example an application-specific integrated semiconductor circuit (ASIC), converted into suitable commands for driving the computer 7. The ASIC 4 subjects the output signals of the microphone 3 to an algorithm for automatic speaker identification (if a voice-recognition algorithm is not implemented that is independent of the voice of the particular speaker), voice recognition and voice analysis, and interprets them as control signals for the connected computer.

Preferably, the control signals are such that they are consistent with the configuration/setting or the operation of the input device or the webcam. Settings (seizure of the degrees of freedom of the input device, etc.) can therefore be undertaken or functions initiated by voice. In that case, the driver software (normally in the computer) for the input device or the webcam has a function that makes possible the evaluation of the voice-controlled control signals.

The processor 4 for the voice-signal evaluation is in that case preferably fitted in the housing of the input device or of the webcam, normally as a special assembly separately from the processors for the video-signal evaluation or the evaluation of the signals from the input device. The voice-signal evaluation can preferably be stored as firmware.

The converted and evaluated commands are then transmitted to the computer 7 via the same interface 8 as is provided also for the transmission of the other drive commands via the mouse 1 or the keyboard 1′ to control the cursor or the mouse pointer.

Consequently, only a single connection 6 (for example, USB connection) of the computer 7 is advantageously occupied for the input of voice-control signals and the input of the other drive commands. The conversion of the voice-control signals into control commands that can be executed by the computer 7 may, of course, also take place in the computer 7 itself. In that case, (digitized) voice signals are transmitted via the interface 8.

The voice-control function can be activated by means of a special key (key 5 in the case of the mouse 1 or key 5′ in the case of the keyboard 1′) on the manual input device 1, 1′.

Incidentally, it is also possible to activate (“wake up”) the operation of the mouse 1 by means of voice commands, which is an example of how voice commands can be used specifically for the operation of an input device.

Incidentally, it is also advantageous if the driver software for the input device automatically activates the voice-control function as soon as the input device 1, 1′ or the webcam 1″ is connected to the appropriate connection 6 (for example, a USB connection 6 or a serial RS 232 interface, etc.) of the computer 7. In particular, the voice-control function or the voice-control activation function may already be incorporated in the driver software, which reduces the installation cost for the user. The voice control is then available at the same time as the manual input device 1, 1′ is connected.

Instead of the wire-connected interface 8 shown in FIGS. 1 to 4, which serves for the combined transmission of the voice-control signals converted into electrical signals, recognized, voice-analysed and interpreted together with the other drive commands, a wireless interface known from the prior art can, of course, also be used. Suitable for said wireless interface is, inter alia, an infrared interface or an interface according to the Bluetooth standard.

List of Reference Characters

| No. | Technical function component or system component |
|---|---|
| 1 | Force/moment sensor or mouse of the computer 7 as |
| | manual input device for control commands |
| 1′ | Keyboard of the computer 7 as manual input device |
| | for control commands and information items |
| 1″ | Internet camera attachment (“webcam”) of the |
| | computer 7 |
| 1a | Cable connection to the computer 7 |
| 1b | Operating part of the manual input device 1 |
| | Baseplate of the manual input device 1 |
| 1d | Function keys of the baseplate 1c |
| 1e | Display device with touch screen incorporated in the |
| | baseplate 1c or the operating part 1b of the manual |
| | input device 1 |
| 1f | (Imaginary) vertical longitudinal axis of the |
| | operating part 1b |
| 2 | Housing of the force/moment sensor or of the mouse 1 |
| 2′ | Housing of the keyboard 1′ |
| 2″ | Housing of the Internet camera attachment 1″ |
| 2′ ′ ′ | Housing of the display screen 7a |
| 3 | Microphone, incorporated in the housing 2, 2′, 2″ or |
| | 2′ ′ ′ of the force/moment sensor or mouse 1, of the |
| | keyboard 1′, of the Internet camera attachment 1″ |
| | and/or of the display screen 7a |
| 4 | Processing unit (microprocessor) implemented as an |
| | application-specific integrated semiconductor |
| | circuit (ASIC) that subjects the voice-control |
| | signals of a user detected by the microphone 3 to an |
| | algorithm for automatic speaker identification, |
| | voice recognition, voice analysis and/or voice |
| | interpretation |
| 5 | Key on the computer mouse 1 for manually activating |
| | the voice-control function |
| 5′ | Key on the keyboard 1′ for manually activating the |
| | voice-control function |
| 5″ | Key on the Internet camera attachment 1″ for |
| | manually activating the voice-control function |
| 5′ ′ ′ | Key on the computer display screen 7a for manually |
| | activating the voice-control function |
| 6 | USB connection or serial RS 232 interface of the |
| | computer 7 for the input of voice commands and/or |
| | other drive commands |
| 7 | Computer unit (computer) for the real-time movement |
| | control of real and/or virtual objects graphically |
| | visualized with the aid of a display screen 7a |
| 7a | Display screen of the computer 7 |
| 8 | Common (wire-connected or wireless) interface for |
| | the transmission of processed and recognized voice- |
| | control signals and/or other drive commands via the |
| | manual input device 1, 1′ or 1″ to the computer 7 |
| 100 | A first exemplary embodiment of a system for the |
| | generation of control signals for the real-time |
| | movement control of real or virtual objects in |
| | accordance with the present invention, in which a |
| | microphone for the recording and conversion of |
| | acoustic voice-control signals into electrical |
| | signals, an ASIC for automatic speaker |
| | identification, voice recognition, voice analysis |
| | and voice interpretation, and a key for the manual |
| | activation of the voice-control function are |
| | incorporated in the housing of a computer mouse |
| 200 | A second exemplary embodiment of a system for the |
| | generation of control signals for the real-time |
| | movement control of real or virtual objects in |
| | accordance with the present invention, in which a |
| | microphone for the recording and conversion of |
| | acoustic voice-control signals into electrical |
| | signals, an ASIC for automatic speaker |
| | identification, voice recognition, voice analysis |
| | and voice interpretation, and a key for the manual |
| | activation of the voice-control function are |
| | incorporated in the housing of a computer keyboard |
| 300 | A third exemplary embodiment of a system for the |
| | generation of control signals for the real-time |
| | movement control of real or virtual objects in |
| | accordance with the present invention, in which a |
| | microphone for the recording and conversion of |
| | acoustic voice-control signals into electrical |
| | signals, an ASIC for automatic speaker |
| | identification, voice recognition, voice analysis |
| | and voice interpretation, and a key for the manual |
| | activation of the voice-control function are |
| | incorporated in the housing of an Internet camera |
| | attachment (“webcam”) |
| 400 | A fourth exemplary embodiment of a system for the |
| | generation of control signals for the real-time |
| | movement control of real or virtual objects in |
| | accordance with the present invention, in which a |
| | microphone for the recording and conversion of |
| | acoustic voice-control signals into electrical |
| | signals, an ASIC for automatic speaker |
| | identification, voice recognition, voice analysis |
| | and voice interpretation, and a key for the manual |
| | activation of the voice-control function are |
| | incorporated in the housing of a computer display |
| | screen |
| X | Three-dimensional view of the manual input device 1 |
| | and of the baseplate 1c having a 3D coordinate |
| | system in which the six degrees of freedom |
| | x, y, z [m] and Φₓ, Φ_{y}, Φ_{z} [rad] |
| | of the manual input device 1 and also their first |
| | and second time derivatives |
| | \dot{x}, \dot{y}, \dot{z}[m · s⁻¹] and \dot{Φ}ₓ, \dot{Φ}_{y}, \dot{Φ}_{z}(rad · s⁻¹] and also |
| | \ddot{x}, ÿ, \ddot{z}[m · s⁻²] and \ddot{Φ}ₓ, \ddot{Φ}_{y}, \ddot{Φ}_{z}[rad · s⁻²] |
| | are shown. |

1. Manual input device for the generation of control signals for the real-time movement control of real and/or virtual objects graphically visualized with the aid of a display device (7a), characterized in that a microphone (3) for the recording and conversion of acoustic voice-control signals into electrical signals is incorporated in the housing (2, 2′) of the manual input device (1, 1′).

2. Manual input device according to claim 1, characterized in that the housing (2, 2′) furthermore incorporates a processing unit (4) that subjects the output signals of the microphone (3) to an algorithm for automatic speaker identification, voice recognition and voice analysis and interprets them as control signals for the real-time movement of at least one of the graphically visualized objects.

3. Manual input device according to claim 2, characterized in that the processing unit (4) is designed as an application-specific integrated semiconductor circuit (ASIC).

4. Manual input device according to any one of the preceding claims, characterized in that it is a computer mouse or a force/moment sensor (1) or a keyboard (1′).

5. Manual input device according to any one of the preceding claims, characterized in that the voice-control function can be activated by actuation (5, 5′) of the manual input device (1, 1′).

6. Manual input device according to any one of the preceding claims, characterized by a driver software that automatically activates the voice-control function as soon as the input device (1, 1′) is connected to a connection (6) of a computer unit (7).

7. Manual input device according to claim 6, characterized in that the function for the automatic activation of the voice-control function is integrated in the driver software that is provided for the conversion of the other drive signals by means of a computer mouse (1) and keyboard (1′).

8. Manual input device according to any one of the preceding claims, characterized in that the voice-control signals converted into electrical signals, recognized, voice-analysed and interpreted are transmitted together with the other drive commands via a common wire-connected or wireless interface (8) to a computer unit (7).

9. Internet camera attachment for a computer device (7) for the real-time movement control of real and/or virtual objects graphically visualized with the aid of a display device (7a), characterized in that a microphone (3) is incorporated in the housing (2″) of the Internet camera attachment (1″) for the recording and conversion of acoustic voice-control signals into electrical signals or a microphone (3) is permanently fitted on the housing (2″).

10. Internet camera attachment according to claim 9, characterized in that there is furthermore incorporated in its housing (2″) a processing unit (4) that subjects the output signals of the microphone (3) to an algorithm for automatic speaker identification, voice recognition and voice analysis and interprets them as control signals for the real-time movement of at least one of the graphically visualized objects.

11. Internet camera attachment according to claim 10, characterized in that the processing unit (4) is designed as an application-specific integrated semiconductor circuit (ASIC).

12. Internet camera attachment according to any one of claims 9 to 11, characterized in that the voice-control function can be activated by the actuation of a key (5″) incorporated in the housing (2″) of the Internet camera attachment (1″).

13. Internet camera attachment according to any one of claims 9 to 12, characterized by a driver software that automatically activates the voice-control function as soon as the Internet camera attachment (1″) is connected to a connection (6) of the computer unit (7).

14. Internet camera attachment according to any one of claims 9 to 13, characterized in that the function for the automatic activation of the voice-control function is incorporated in the driver software that is provided for the conversion of the other drive signals.

15. Internet camera attachment according to any one of claims 9 to 14, characterized in that the voice-control signals converted into electrical signals, recognized, voice-analysed and interpreted are transmitted together with the other drive commands via a common wire-connected or wireless interface (8) to the computer unit (7).

16. Display device for a computer device (7) for the graphical visualization of the real-time movement control of real and/or virtual objects, characterized in that a microphone (3) is incorporated in the housing (2′″) of the display device (7a) or a microphone (3) is permanently mounted on its housing (2′″).

17. Display device according to claim 16, characterized in that there is furthermore incorporated in its housing (2′″) a processing unit (4) that subjects the output signals of the microphone (3) to an algorithm for automatic speaker identification, voice recognition and voice analysis and interprets them as control signals for the real-time movement of at least one of the graphically visualized objects.

18. Display device according to claim 17, characterized in that the processing unit (4) is designed as an application-specific integrated semiconductor circuit (ASIC).

19. Display device according to any one of claims 16 to 18, characterized in that the voice-control function can be activated by the actuation of a key (5′″) incorporated in the housing (2′″) of the display device (7a).

20. Display device according to any one of claims 16 to 19, characterized by a driver software that automatically activates the voice-control function as soon as the display device (7a) is connected to a connection (6) of the computer unit (7).

21. Display device according to claim 20, characterized in that the function for the automatic activation of the voice-control function is incorporated in the driver software that is provided for the conversion of the other drive signals by means of computer mouse (1) and keyboard (1′).

22. Display device according to any one of claims 16 to 21, characterized in that the voice-control signals converted into electrical signals, recognized, voice-analysed and interpreted are transmitted together with the other drive commands via a common wire-connected or wireless interface (8) to a computer unit (7).

23. Use of a manual input device (1, 1′) according to any one of claims 1 to 8 in combination with a CAD program.

24. Use of a manual input device (1, 1′) according to any one of claims 1 to 8 in combination with a desktop publishing program.

25. Use of an Internet camera attachment (1″) according to any one of claims 9 to 15 in combination with a CAD program.

26. Use of an Internet camera attachment (1″) according to any one of claims 9 to 15 in combination with a desktop publishing program.

27. Use of a display device according to any one of claims 16 to 22 in combination with a CAD program.

28. Use of a display device according to any one of claims 16 to 22 in combination with a desktop publishing program.
